(19) United States
(12) Patent Application Publication
(10) Pub. No.: US 2013/0121926 A1
(43) Pub. Date: May 16, 2013

(54) DYE COMPOSITIONS AND DYE SYNTHESES

(71) Applicants: Radha Achanath, Bangalore (IN); Srinath Balaji, Bangalore (IN); John Henrik Johansen, Oslo (NO)

(72) Inventors: Radha Achanath, Bangalore (IN); Srinath Balaji, Bangalore (IN); John Henrik Johansen, Oslo (NO)

(73) Assignee: GE HEALTHCARE AS, Oslo (NO)

(21) Appl. No.: 13/805,457

(22) PCT Filed: Jun. 29, 2011
(86) PCT No.: PCT/EP2011/060919

§ 371 Date: Dec. 19, 2012

(30) Foreign Application Priority Data
Jun. 29, 2010 (IN) 1010878.5

(51) Int. Cl. C09B 23/08

(52) U.S. Cl. CPC C09B 23/086
USPC 424/9.6; 548/455

(57) ABSTRACT

The present invention relates to sulfonated optical dye compositions, especially dyes suitable for biological applications in vitro, and for in vivo imaging. Improved dye compositions and intermediates are provided, which enable the suppression of undesirable newly-identified impurities. Also provided is the use of the improved dye compositions in the preparation of conjugates with biological targeting molecules.

### FIELD OF THE INVENTION

The present invention relates to the field of sulfonated optical dyes, especially dyes suitable for biological applications in vitro, and for in vivo imaging. Improved dye compositions and intermediates are provided, which enable the suppression of undesirable newly-identified impurities.

### BACKGROUND TO THE INVENTION

The sulfonation of dyes by the introduction of sulfonate (—SO₃H or —SO₃⁻) substituents is an established method of increasing the water solubility of the dye.

WO 01/43781 discloses the synthesis of new class of symmetrical heptamethine cyanine dyes and also provides a method for fluorescence imaging.

Wang et al [Dyes and Pigments, 61, 103-107 (2004)] discloses the synthesis of heptamethine cyanine dyes and their spectral properties in SiO₂ sol-gel.

WO 2005/044923 and U.S. 2007/0203343 A1 disclose the synthesis of new class of sulfonated pentamethine and heptamethine cyanine dyes useful for the labelling and detection of biological molecules. Included is the synthesis of the unsymmetrical cyanine dye Cy7, and its N-hydroxysuccinimide (NHS) ester:

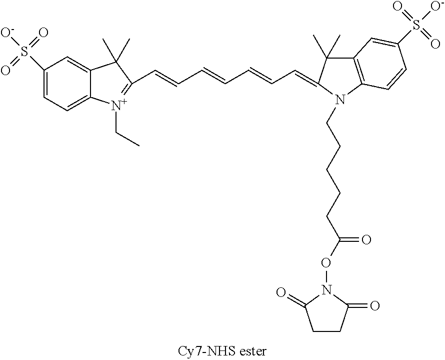 [SMILES: CC[N+]1=C(/C=C/C=C/C=C/C=C2\N(CCCCCC(=O)ON3C(=O)CCC3=O)c3ccc(S(=O)(=O)[O-])cc3C2(C)C)C(C)(C)c2cc(S(=O)(=O)[O-])ccc21]

WO 2005/123768 discloses conjugates of sulfonated cyanine dyes with RGD peptides, and the use of the conjugates in diagnostic optical imaging techniques.

Jiang et al [Tet. Lett., 48 5825-5829 (2007)] disclose an efficient approach to the synthesis of unsymmetrical water-soluble cyanine dyes using poly(ethylene glycol) as a soluble support.

WO 2008/139207 discloses the synthesis of a specific class of unsymmetrical pentamethine cyanine dyes and their use as imaging agents for in vivo optical imaging.

Prior art dye syntheses, especially unsymmetrical cyanine dye syntheses, do however suffer from low yields with complex, labour-intensive purification methods (eg. preparative HPLC), which are most suited to milligramme scale due to sample loading considerations. When used for biological applications, especially in vivo optical imaging, there is a need for such dyes being obtainable in gramme quantities, at pharmaceutical grade, with suppression of unwanted impurities.

### THE PRESENT INVENTION

The present invention provides compositions useful in the synthesis of sulfonated optical dyes, wherein previously unrecognised impurities are identified and suppressed. Identification and control of such impurities is important for Good Manufacturing Practice (GMP). Dye intermediate compositions useful in the synthesis of unsymmetrical optical dyes are also provided, as well as dye preparation methods which provide improved dye compositions by suppression of key impurities.

The present invention permits the preparation of sulfonated dyes in gramme quantities, at pharmaceutical grade, with suppression of unwanted impurities. The compositions and methods are particularly useful when preparing such sulfonated dyes for biological applications, especially in vivo optical imaging.

### DETAILED DESCRIPTION OF THE INVENTION

In a first aspect, the present invention provides a precursor composition useful in the synthesis of sulfonated dyes, which comprises a quaternary compound of Formula I and a sulfonate ester of Formula II:

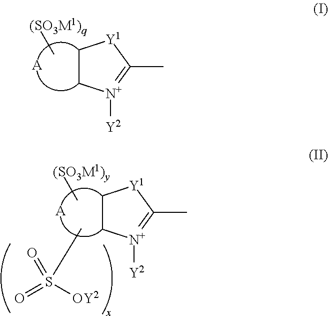

characterised in that said composition comprises less than 3% of the sulfonate ester of Formula II:
wherein:
   A represents the atoms necessary to complete a phenyl or naphthyl ring;
   Y¹ is —O—, —S—, —NR¹— or —CR²R³—;
   Y² is an R group and is the same at all locations within Formula II;
   each M¹ is independently H or B^{c}, where B^{c} is a biocompatible cation;
   R¹ is an R group;
   R² and R³ are independently C₁₋₃ alkyl or C₁₋₆ carboxyalkyl;
   each R is independently C₁₋₅ alkyl or C₁₋₆ carboxyalkyl;
   q is an integer of value 1 to 4;
   x is an integer of value 1 to 4, y is an integer of value 0 to 3, wherein
      x and y are chosen such that (x+y)=q.

In the precursor composition, A, Y¹ and Y² are the same in Formula I and Formula II.

The “dyes” which can be prepared using the compositions of the invention include cyanine dyes. The dyes are sulfonated. By the term “sulfonated” is meant that said dyes have at least one sulfonic acid substituent. By the term “sulfonic acid substituent” is meant a substituent of formula —SO₃M¹, where M¹ is H or B^{c}, and B^{c} is a biocompatible cation. The —SO₃M¹, substituent is covalently bonded to a carbon atom, and the carbon atom may be aryl (such as the A group in Formula I), or alkyl.

By the term “biocompatible cation” (B^{C}) is meant a positively charged counterion which forms a salt with an ionised, negatively charged group (in this case a sulfonate group), where said positively charged counterion is also non-toxic and hence suitable for administration to the mammalian body, especially the human body. Examples of suitable biocompatible cations include: the alkali metals sodium or potassium; the alkaline earth metals calcium and magnesium; and the ammonium ion. Preferred biocompatible cations are sodium and potassium, most preferably sodium.

In Formula II, the —SO₂—OY² substituent is termed a “sulfonate ester” because the definitions of Y² and R require that an —SO₂—OC— ester covalent bond is present.

In Formulae I and II, when A is the atoms necessary to complete a phenyl ring, indole rings are generated corresponding to the ring system shown in Formula IA and IIA (below). When A is the atoms necessary to complete a napthalene ring, that denotes a ring structure analogous to Formulae IA or IIA, wherein an additional phenyl ring is fused to the phenyl ring therein. When the composition of the first aspect comprises a napthalene ring in Formulae I/II, the sulfonate and sulfonate ester substituents may be at any position of the naphthalene ring. In Formulae I/II, the phenyl or naphthalene rings may optionally be substituted with additional substituents.

By the term “comprises less than 3% of the sulfonate ester” is meant that the composition comprises less than 3.0 mole percent of the sulfonate ester of Formula II. When the precursor composition comprises less than 3% of the sulfonate ester, the remainder is suitably at least 90 mole percent the quaternary compound of Formula I.

The sulfonate esters of Formula II are previously unknown impurities in compositions comprising the compounds of Formula I. They arise from undesirable O-alkylation, in addition to the desired N-alkylation in the synthesis of the quaternary compound of Formula I. The suppression of said sulfonate esters in the precursor composition is important. That is because, if present, they would react further in the next synthesis step—which could be either the preparation of the amide of Formula V of the second embodiment, or the preparation of symmetrical or unsymmetrical dyes. The outcome would be unwanted sulfonate ester impurities being carried through into the dye composition product, and such impurities would be difficult to separate at that stage.

### Preferred Aspects

Preferably, the precursor composition of the first aspect comprises less than 2% of the sulfonate ester of Formula II, and at least 94 mole percent the compound of Formula I; most preferably less than 1% sulfonate ester of Formula II, and at least 95 mole percent of the compound of Formula I.

In the precursor composition, Y¹ is preferably —CR²R³—. When Y¹ is —CR²R³—, R² and R³ are preferably both independently C₁₋₃ alkyl; most preferably R²═R³═CH₃. In the precursor composition, q is preferably 1 or 2, and is most preferably 1.

In the precursor composition, preferably the quaternary compound is of Formula IA and the sulfonate ester is of Formula IIA:

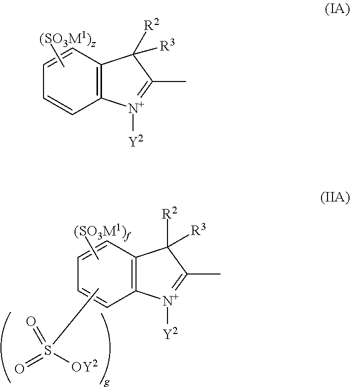

where: z is 1 or 2;
f is 0 or 1, g is 1 or 2 and (f+g)=z.

In the precursor composition of Formula IA/IIA, z is preferably 1. When z is 1, the —SO³M¹ substituent is preferably in the para-position to the indole N atom. In Formula IA/IIA, preferred and most preferred R², R³ and Y² groups are as described for Formulae I/II (above). An especially preferred precursor composition is when the quaternary compound is of Formula IAA and the sulfonate ester is of Formula IIAA:

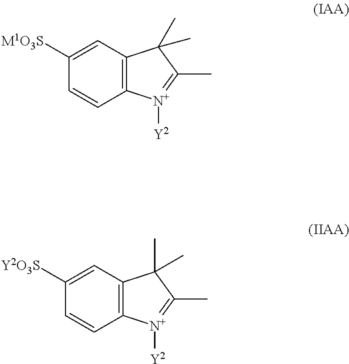

In Formula IAA/IIAA, preferred and most preferred Y² groups are as described for Formulae I/II (above).

The precursor compositions of the first aspect can be obtained by alkylating a compound of Formula B:

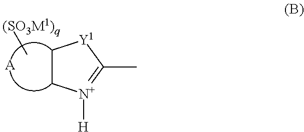

with an alkylating agent of formula Y²-Hal, where Hal is halogen, in a suitable solvent and Y² is as defined for Formulae I and II. For Y²-Hal, Hal is preferably Cl, Br or I, most preferably Br. The suitable solvent is typically sulfolane, and the reaction is suitably carried out at 80-120° C., preferably 90-120° C. for 6 to 16 hours. Compound 1 (5-sulfo-2,3,3-trimethyl indolenine sodium salt) is commercially available from “Intatrade Chemicals”.

In one embodiment, the impurity sulfonate ester of Formula II is minimised by an improved work up procedure. Thus, after the alkylation of Compound B, the solvent was removed in vacuo, and the residue dissolved in 10 volumes of water and washed with ethyl acetate (5 volumes). The ethyl acetate wash removes traces of alkylating agent Y²-Hal, which would otherwise lead to the formation of the sulfonate ester impurity under the slightly acidic conditions of the subsequent step.

In the case of Compound 3, after the alkylation of the compound of Formula B, the reaction mixture was diluted with ethyl acetate and stirred for few minutes to obtain a thick tar like precipitate. The ethyl acetate layer (containing excess alkylating agent and sulfolane) was decanted and the residue repeatedly washed with ethyl acetate, and the ethyl acetate layer decanted, to remove most of the sulfolane and alkylating agent. Residual traces of alkylating agent trapped in the residue were removed by dissolving the residue in 10 volumes of water and further washing the aqueous layer with ethyl acetate. The aqueous layer was then subjected to hydrolysis using sodium hydroxide.

For Compound 3 (see FIG. 1) this modified work up procedure resulted in reducing the level of impurity sulfonate ester II in the composition from 5-6% to <1% and thereby increased the purity of Compound 3 from 89% to 96%. Further, Compound 3 was always isolated as a thick sticky mass after the reaction, which was difficult to handle. The recrystallisation of Compound 3 was a major challenge as it was found to have very poor solubility in most common organic solvents such as acetone, isopropyl alcohol, acetonitrile, acetic acid and DMF (dimethylformamide). There was good solubility in simple alcohols such as methanol and ethanol, but those are unsuitable since they readily form the corresponding carboxylic acid ester of Compound 3 as an impurity. The present inventors have observed that a mixture of acetone and isopropyl alcohol (IPA) can solve the problem and have successfully isolated Compound 3 as crystals by triturating with a mixture of acetone/isopropyl alcohol (70/30 ratio). As noted above, Compound 3 after work up is insoluble in individual solvents like acetone and IPA, but trituration of the crude compound with a mixture of Acetone/IPA (70:30) allowed the product to crystallize out. The purity achieved was 96%. The effective removal of impurity in the polar solvent combination is responsible for this drastic improvement. The recrystallisation should be carried out within 1 or 2-hours. That is because the reactivity of isopropanol is low when compared to methanol and ethanol, and so the formation of isopropyl ester of carboxylic acid is very much less likely. When Compound 3 was left in isopropanol/acetone mixture for longer periods (16 hrs), however, the isopropyl ester of the carboxylic acid could be detected (by LCMS).

Compound 2 has been described in the prior art [Mujumdar et al Bioconj. Chem., 4 (2), 105-111 (1993)]. For Compound 2, the crude product of the alkylation reaction had a purity of 90-92%. The present inventors have found that, for Compound 2, recrystallisation from methanol removed the sulfonate ester and improved the purity from 90-92% to 98%.

The purities of the Precursor composition are quoted via analytical HPLC determination (area under the curve) at two different wavelengths—254 nm and 270 nm. The sulfonate impurity was characterized by LCMS.

In a second aspect, the present invention provides a dye composition which comprises an unsymmetrical cyanine dye of Formula IV, and symmetrical cyanine dyes of Formulae VI and VII:

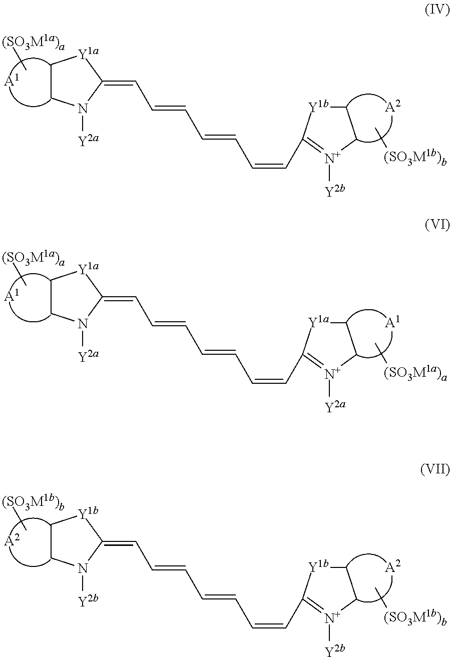

characterised in that said composition contains less than 8% in total of the symmetrical dyes of Formulae VI and VII;
wherein:
   A¹ and A² are independently A groups as defined in the first aspect;
   M^{1a} and M^{1b} are independently M¹ groups as defined in the first aspect;
   Y^{1a} and Y^{1b} are independently Y¹ groups as defined in the first aspect;
   Y^{2a} and Y^{2b} are independently Y² groups as defined in the first aspect;
   a and b are independently q groups as defined in the first aspect;
and wherein at least one of A¹, Y^{1a} and Y^{2a} is different from A², Y^{1b} and Y^{2b} respectively.

By the term “comprises less than 8% in total of the symmetrical dyes of Formulae VI and VII” is meant that the composition comprises less than 8.0 mole percent of the sum of [symmetrical dye VI plus symmetrical dye VI] present in the dye composition. The remainder is suitably at least 90 mole percent of the unsymmetrical cyanine dye of Formula IV.

Preferred aspects of the various A, M¹, Y¹ and Y² groups in the second aspect are as described in the first aspect (above).

In the second aspect, the dye of Formula IV preferably comprises at least one, more preferably one carboxyalkyl substituent chosen from the R¹ and R groups. That makes the dye bifunctional, by providing a functional group (carboxyl) through which the dye can be attached to biological molecules—as described in the further aspect (below).

Whilst some unsymmetrical cyanine dyes of Formula IV are known in the prior art, the unsymmetrical cyanine dye compositions of the second aspect were not understood, because the identities of the key impurities were not known. In addition to identifying such impurities, the present invention provides methods for controlling such impurities to give the improved compositions of the second aspect. The symmetrical impurity dyes of Formula VI and VII, if carried through into the dye product would be quite difficult to separate and remove due to the similar chemical characteristics to unsymmetrical dye IV. Having similar optical properties, they would interfere with the biological applications of dyes of Formula IV in vitro and in vivo.

In the dye composition of the second aspect, A¹ and A² are preferably both the atoms necessary to complete a phenyl ring. ‘a’ and ‘b’ are preferably z where z is as defined above, and is most preferably 1. Y^{1a} and Y^{2a} are preferably both independently —CR²R³—.

In the dye composition of the second aspect, the composition also preferably contains less than 4% sulfonate ester impurities in the dye composition, more preferably less than 2%, most preferably less than 1%. Said sulfonate esters correspond to analogues of Formula IV, VI and VII in which a proportion of the —SO₃M^{1a} and/or —SO₃M^{1b} substituents are present as —SO₂(OY²) sulfonate esters, where M^{1a}, M^{1b} and Y² are as described for the first aspect (above).

The dye compositions of the second aspect can be obtained via the intermediate compositions of the third aspect and the process of the fourth aspect.

In a third aspect, the present invention provides an intermediate composition which comprises an amide of Formula V and a polyene salt of Formula X:

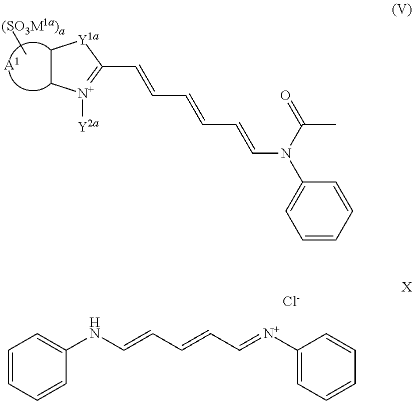

characterised in that said composition comprises less than 1% of polyene salt X;
wherein:
A¹, M^{1a}, Y^{1a} and Y^{2a} and preferred aspects thereof are as defined in the second aspect.

The intermediate compositions of the third aspect are useful in the synthesis of sulfonated dyes, especially the unsymmetrical cyanine dye compositions of the second aspect, or the symmetrical dye preparation process of the fifth aspect. The unsymmetrical cyanine dyes are preferred, since such dyes can eg. have a single carboxyalkyl substituent and hence a single point of attachment when preparing bifunctional dye derivatives for conjugating to biological molecules.

By the term “comprises less than 1% of the polyene salt of Formula X” is meant that the composition comprises less than 1.0 mole percent of the polyene salt in the intermediate composition. The remainder is suitably at least 90 mole percent of the unsymmetrical cyanine dye of Formula IV. Preferably the intermediate composition comprises less than 0.5% of the polyene salt of Formula X, most preferably less than 0.1%.

The present inventors have found that it is extremely important to suppress the level of polyene salt X in the intermediate composition, since any remaining polyene salt X would react in the process step of the fourth aspect, to form undesirable symmetrical dyes of Formulae VI and VII as described above. Thus, the present inventors have found that prior art syntheses of the unsymmetrical cyanine dye Compound 4 (Cy7) generate up to 10-15% each of the unwanted symmetrical dyes VI and VII. Once formed and present in the composition, these impurity dyes of course have similar characteristics to the desired product IV. Consequently they are difficult to separate chromatographically on a preparative scale, and hence suppression of their formation in the first place is key. The intermediate composition of the third aspect is thus an important means of accessing the improved dye compositions of the second aspect.

The intermediate composition preferably further comprises less than 1 mole per cent, more preferably less than 0.5%, most preferably less than 0.1% of acetanilide. Acetanilide [i.e. C₆H₅NH(C═O)CH₃] is a by-product of the reaction of the precursor composition with the polyene salt X. It is important to remove the acetanilide, since the present inventors have found that, when present in the dye composition of the second aspect, it can be difficult to separate and remove since it co-elutes with Compound 4 on preparative HPLC.

The intermediate composition preferably further comprises less than 1% of the symmetrical cyanine dye of Formula III:

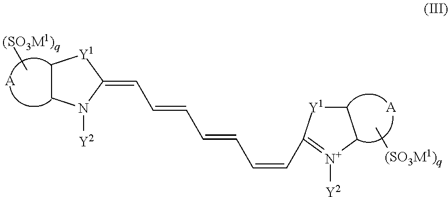

where A, M¹, Y¹, Y² and q are as defined in the first aspect.

The polyene salt of Formula X is commercially available from eg. Sigma-Aldrich.

The standard literature procedure for the synthesis of cyanine dyes employ a mixture of acetic acid and acetic anhydride as solvent, and potassium acetate as the base. The present invention provides a scalable, high yielding synthesis in an acceptable solvent. Thus, the role of acetic anhydride is changed from solvent to reactant and the amount of organic solvent used is minimised.

The intermediate compositions of the third aspect are thus obtained by reaction of the precursor composition of the first aspect with 1.2 to 1.8, preferably 1.4 to 1.6, most preferably about 1.5 equivalents of the polyene salt X (as defined above), in a suitable solvent. The use of excess polyene salt X is to ensure that there is no symmetrical dye impurity formation in the intermediate composition. The excess polyene salt X is removed to <1% using ethyl acetate before the intermediate composition is used in the dye composition synthesis of the fourth aspect.

The suitable solvent can be acetone or acetonitrile, but is preferably acetonitrile. The polyene salt (X) has been found to be very sensitive to temperature. Thus, attempts to heat the reaction mixture to a temperature of 110° C., were found to cause decomposition and loss of polyene salt (X). That in turn resulted in an increased level of symmetrical dye impurities of Formula III due to the excess of indole precursor over the polyene salt. The reaction is therefore preferably carried out at room temperature.

For Compound 7 (see FIG. 1), the reaction is carried out in acetonitrile at 25° C. for 1 hr, in the presence of N,N-diisopropylethylamine (DIEA; 1.5 equivalents) and acetic anhydride (5 equivalents). After the reaction was complete, the acetonitrile was removed at 25° C. in vacuo. The removal of solvent at low temperature was found to be critical. Thus, it was observed that the evaporation of acetonitrile at higher temperature (45° C.) resulted in the formation of impurity Compound 5. The residue obtained after removal of acetonitrile was triturated with 100 volumes of ethyl acetate for 30 minutes. This resulted in the formation of a red crystalline solid. The solid

Compound 7 was isolated with a yield of 90% and a purity of 92-93% (by HPLC at 550nm). The acetanilide and excess polyene salt X were effectively suppressed by using ethyl acetate and the low temperature evaporation as described above. Alternatively, the residue after evaporation of the acetonitrile an be taken up in water, and the acetanilide and other impurities removed by continuous extraction with ethyl acetate.

In a fourth aspect, the present invention provides a process for the preparation of the dye composition of the second aspect, which comprises reaction of the intermediate composition of the third aspect, with one molar equivalent of the precursor composition of the first aspect in a suitable solvent, wherein for said precursor composition the quaternary compound is of Formula IB and the sulfonate ester is of Formula IIB:

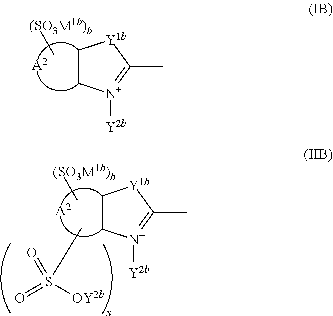

wherein:
A¹, A², M¹¹, M^{1b}, Y^{1a}, Y^{1b}, Y^{2a}, Y^{2b}, a and b and preferred aspects thereof are as described in the second aspect (above).
For the fourth aspect, it is preferred that A¹=A² and Y^{1a}=Y^{1b}.

The “suitable solvent” and preferred aspects thereof are as defined for the third aspect (above).

The preparation of the fourth aspect is summarised in Scheme 1 for Compound 4. The reaction is carried out in two steps, starting from the precursor composition of the first aspect, where the quaternary compound is Compound 3. In the first step, the dye intermediate composition of the third aspect comprising Compound 7 is prepared via reaction of the precursor composition with Compound X as shown. The intermediate composition is preferably isolated and/or purified before use in the next step. In the second step, the intermediate composition is converted to the desired unsymmetrical composition of the second aspect by reaction with a different precursor composition, this time comprising Compound 2. Addition of the Compound 2 precursor composition followed by 5 equivalents of DIEA immediately produced Compound 4, with only traces of symmetrical dye when less than one equivalent of Compound 2 (preferably about 0.75 equivalents) was used. The resulting reaction mixture contains mainly Compound 4, plus 2 equivalents of acetanilide and more than 6 equivalents of DIEA and salts.

The present inventors have found that, precipitation of the reaction mixture by pouring into excess ethyl acetate is effective to remove both acetanilide and any residual Compound 7 from the crude Compound 4. Trituration of the isolated Compound 4 solid in acetone was effective to remove the acetate salt of DIPEA. The symmetric dye impurities of Formulae VI and VII were removed by preparative HPLC. Further details are provided in the Examples (below).

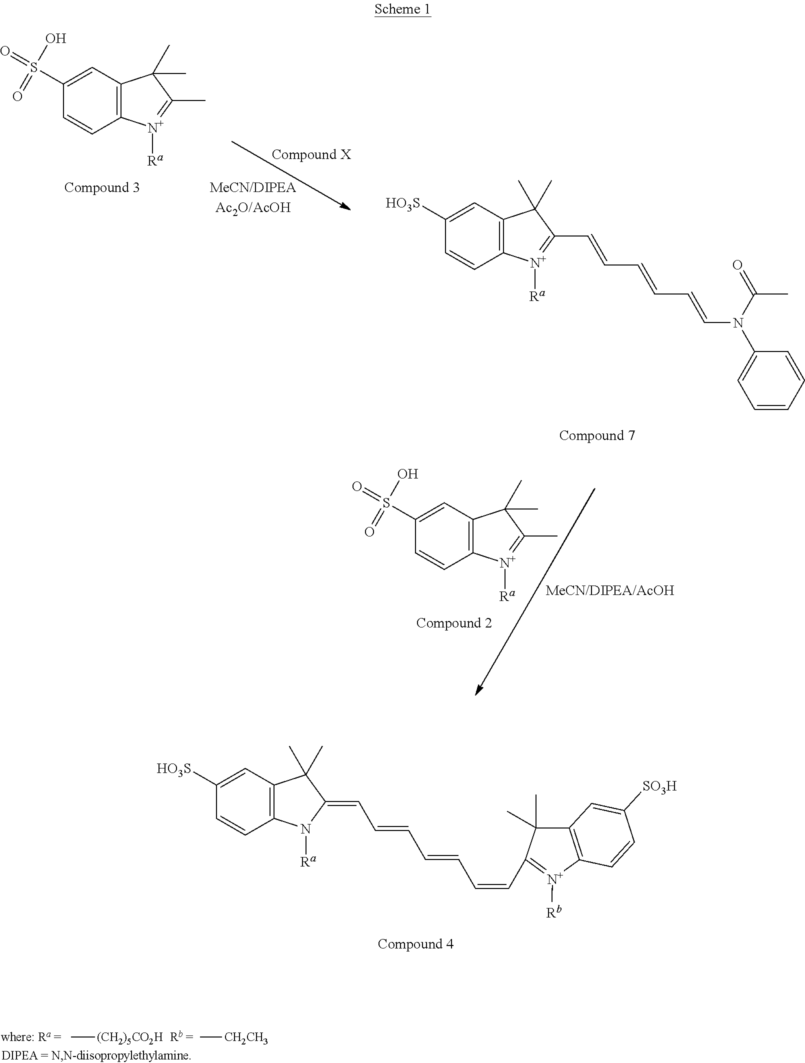

In a fifth aspect, the present invention provides a process for the preparation of a symmetrical cyanine dye of Formula III, as defined in the third aspect, wherein said process comprises reaction of the precursor composition of the first aspect with at least 2 molar equivalents of the polyene salt of Formula X as described in the third aspect, in a suitable solvent.

The “suitable solvent” and preferred aspects thereof are as defined for the third aspect (above).

Thus, the precursor compositions of the first aspect are useful for the preparation of both symmetrical and unsymmetrical dye compositions.

In a sixth aspect, the present invention provides the use of the precursor composition of the first aspect in the synthesis of a sulfonated dye, or in the synthesis of the intermediate composition of the third aspect.

In a seventh aspect, the present invention provides the use of the intermediate composition of the third aspect in the synthesis of a sulfonated dye.

In the use of the sixth or seventh aspects, the sulfonated dye is preferably the symmetrical cyanine dye of Formula III of the fifth aspect, or the unsymmetrical cyanine dye of Formula IV of the second aspect.

In an eighth aspect, the present invention provides a pharmaceutical composition which comprises the dye composition of the second aspect, in a biocompatible carrier medium, in sterile form suitable for mammalian administration.

The “biocompatible carrier medium” comprises one or more pharmaceutically acceptable adjuvants, excipients or diluents. It is preferably a fluid, especially a liquid, in which the compound of Formula (I) is suspended or dissolved, such that the composition is physiologically tolerable, i.e. can be administered to the mammalian body without toxicity or undue discomfort. The biocompatible carrier medium is suitably an injectable carrier liquid such as sterile, pyrogen-free water for injection; an aqueous solution such as saline (which may advantageously be balanced so that the final product for injection is either isotonic or not hypotonic); an aqueous solution of one or more tonicity-adjusting substances (e.g. salts of plasma cations with biocompatible counterions), sugars (e.g. glucose or sucrose), sugar alcohols (e.g. sorbitol or mannitol), glycols (e.g. glycerol), or other non-ionic polyol materials (e.g. polyethyleneglycols, propylene glycols and the like). The biocompatible carrier medium may also comprise biocompatible organic solvents such as ethanol. Such organic solvents are useful to solubilise more lipophilic compounds or formulations. Preferably the biocompatible carrier medium is pyrogen-free water for injection, isotonic saline or an aqueous ethanol solution. The pH of the biocompatible carrier medium for intravenous injection is suitably in the range 4.0 to 10.5.

The pharmaceutical composition may optionally contain additional excipients such as an antimicrobial preservative, pH-adjusting agent, filler, stabiliser or osmolality adjusting agent. By the term “antimicrobial preservative” is meant an agent which inhibits the growth of potentially harmful micro-organisms such as bacteria, yeasts or moulds. The antimicrobial preservative may also exhibit some bactericidal properties, depending on the dosage employed. The main role of the antimicrobial preservative(s) of the present invention is to inhibit the growth of any such micro-organism in the pharmaceutical composition. The antimicrobial preservative may, however, also optionally be used to inhibit the growth of potentially harmful micro-organisms in one or more components of kits used to prepare said composition prior to administration. Suitable antimicrobial preservative(s) include: the parabens, i.e. methyl, ethyl, propyl or butyl paraben or mixtures thereof; benzyl alcohol; phenol; cresol; cetrimide and thiomersal. Preferred antimicrobial preservative(s) are the parabens.

The term “pH-adjusting agent” means a compound or mixture of compounds useful to ensure that the pH of the composition is within acceptable limits (approximately pH 4.0 to 10.5) for human or mammalian administration. Suitable such pH-adjusting agents include pharmaceutically acceptable buffers, such as tricine, phosphate or TRIS [i.e. tris(hydroxymethyl)aminomethane], and pharmaceutically acceptable bases such as sodium carbonate, sodium bicarbonate or mixtures thereof. When the composition is employed in kit form, the pH adjusting agent may optionally be provided in a separate vial or container, so that the user of the kit can adjust the pH as part of a multi-step procedure.

By the term “filler” is meant a pharmaceutically acceptable bulking agent which may facilitate material handling during production and lyophilisation. Suitable fillers include inorganic salts such as sodium chloride, and water soluble sugars or sugar alcohols such as sucrose, maltose, mannitol or trehalose.

The pharmaceutical compositions may be prepared under aseptic manufacture (i.e. clean room) conditions to give the desired sterile, non-pyrogenic product. It is preferred that the key components, especially the associated reagents plus those parts of the apparatus which come into contact with the imaging agent (e.g. vials) are sterile. The components and reagents can be sterilised by methods known in the art, including: sterile filtration, terminal sterilisation using e.g. gamma-irradiation, autoclaving, dry heat or chemical treatment (e.g. with ethylene oxide). It is preferred to sterilise some components in advance, so that the minimum number of manipulations needs to be carried out. As a precaution, however, it is preferred to include at least a sterile filtration step as the final step in the preparation of the pharmaceutical composition.

Preferred aspects of the dye in the composition in the eighth aspect, are as described in the second aspect.

In a further aspect, the present invention provides the use of the dye composition of the second aspect or the pharmaceutical composition of the eight aspect in the preparation of a conjugate of the unsymmetrical dye of Formula IV with a biological targeting moiety or a synthetic macromolecule.

The use of the further aspect includes a method of preparation of said conjugate starting from either the dye composition of the second aspect, or the pharmaceutical composition of the eight aspect. The dye-BTM conjugates of this aspect have applications both in vitro and in vivo.

In the use of the further aspect, preferred aspects of the dye are as described in the second aspect. The dye is preferably used as the pharmaceutical composition of the eight aspect.

By the term “biological targeting moiety” (BTM) is meant a compound which, after administration, is taken up selectively or localises at a particular site of the mammalian body in vivo. Such sites may for example be implicated in a particular disease state or be indicative of how an organ or metabolic process is functioning.

By the term “synthetic macromolecule” is meant a polymer of molecular weight 2 to 100 kDa, preferably 3 to 50 kDa, most preferably 4 to 30 kDa. The polymer can be a polyamino acid such as polylysine or polyglycollic acid, or a polyethyleneglycol (PEG). The term ‘synthetic’ is as defined below.

The BTM may be of synthetic or natural origin, but is preferably synthetic. The term “synthetic” has its conventional meaning, i.e. man-made as opposed to being isolated from natural sources eg. from the mammalian body. Such compounds have the advantage that their manufacture and impurity profile can be fully controlled. Monoclonal antibodies and fragments thereof of natural origin are therefore outside the scope of the term ‘synthetic’ as used herein.

The molecular weight of the BTM is preferably up to 30,000 Daltons. More preferably, the molecular weight is in the range 200 to 20,000 Daltons, most preferably 300 to 18,000 Daltons, with 400 to 16,000 Daltons being especially preferred. When the BTM is a non-peptide, the molecular weight of the BTM is preferably up to 3,000 Daltons, more preferably 200 to 2,500 Daltons, most preferably 300 to 2,000 Daltons, with 400 to 1,500 Daltons being especially preferred.

The biological targeting moiety preferably comprises: a 3-100 mer peptide, peptide analogue, peptoid or peptide mimetic which may be a linear or cyclic peptide or combination thereof; a single amino acid; an enzyme substrate, enzyme antagonist enzyme agonist (including partial agonist) or enzyme inhibitor; receptor-binding compound (including a receptor substrate, antagonist, agonist or substrate); oligonucleotides, or oligo-DNA or oligo-RNA fragments.

By the term “peptide” is meant a compound comprising two or more amino acids, as defined below, linked by a peptide bond (ie. an amide bond linking the amine of one amino acid to the carboxyl of another). The term “peptide mimetic” or “mimetic” refers to biologically active compounds that mimic the biological activity of a peptide or a protein but are no longer peptidic in chemical nature, that is, they no longer contain any peptide bonds (that is, amide bonds between amino acids). Here, the term peptide mimetic is used in a broader sense to include molecules that are no longer completely peptidic in nature, such as pseudo-peptides, semi-peptides and peptoids. The term “peptide analogue” refers to peptides comprising one or more amino acid analogues, as described below. See also “Synthesis of Peptides and Peptidomimetics”, M. Goodman et al, Houben-Weyl E22c, Thieme.

By the term “amino acid” is meant an L- or D-amino acid, amino acid analogue (eg. naphthylalanine) or amino acid mimetic which may be naturally occurring or of purely synthetic origin, and may be optically pure, i.e. a single enantiomer and hence chiral, or a mixture of enantiomers. Conventional 3-letter or single letter abbreviations for amino acids are used herein. Preferably the amino acids of the present invention are optically pure. By the term “amino acid mimetic” is meant synthetic analogues of naturally occurring amino acids which are isosteres, i.e. have been designed to mimic the steric and electronic structure of the natural compound. Such isosteres are well known to those skilled in the art and include but are not limited to depsipeptides, retro-inverso peptides, thioamides, cycloalkanes or 1,5-disubstituted tetrazoles [see M. Goodman, Biopolymers, 24, 137, (1985)]. Radiolabelled amino acids such as tyrosine, histidine or proline are known to be useful in vivo imaging agents.

When the BTM is an enzyme substrate, enzyme antagonist, enzyme agonist, enzyme inhibitor or receptor-binding compound it is preferably a non-peptide, and more preferably is synthetic. By he term “non-peptide” is meant a compound which does not comprise any peptide bonds, ie. an amide bond between two amino acid residues. Suitable enzyme substrates, antagonists, agonists or inhibitors include glucose and glucose analogues such as fluorodeoxyglucose; fatty acids, or elastase, Angiotensin II or metalloproteinase inhibitors. A preferred non-peptide Angiotensin II antagonist is Losartan. Suitable synthetic receptor-binding compounds include estradiol, estrogen, progestin, progesterone and other steroid hormones; ligands for the dopamine D-1 or

D-2 receptor, or dopamine transporter such as tropanes; and ligands for the serotonin receptor.

The BTM is most preferably a 3-100 mer peptide or peptide analogue. When the BTM is a peptide, it is preferably a 4-30 mer peptide, and most preferably a 5 to 28-mer peptide.

When the BTM is an enzyme substrate, enzyme antagonist, enzyme agonist or enzyme inhibitor, preferred such biological targeting molecules of the present invention are synthetic, drug-like small molecules i.e. pharmaceutical molecules. Preferred dopamine transporter ligands such as tropanes; fatty acids; dopamine D-2 receptor ligands; benzamides; amphetamines; benzylguanidines, iomazenil, benzofuran (IBF) or hippuric acid.

When the BTM is a peptide, preferred such peptides include:
somatostatin, octreotide and analogues,
peptides which bind to the ST receptor, where ST refers to the heat-stable toxin produced by E. coli and other micro-organisms;
bombesin;
vasoactive intestinal peptide;
neurotensin;
laminin fragments eg. YIGSR, PDSGR, IKVAV, LRE and KCQAGTFALRGDPQG,
N-formyl chemotactic peptides for targeting sites of leucocyte accumulation,
Platelet factor 4 (PF4) and fragments thereof,
RGD (Arg-Gly-Asp)-containing peptides, which may eg. target angiogenesis [R. Pasqualini et al., Nat Biotechnol. 1997 Jun; 15 (6):542-6]; [E. Ruoslahti, Kidney Int. 1997 May; 51 (5):1413-7].
peptide fragments of α₂-antiplasmin, fibronectin or beta-casein, fibrinogen or thrombospondin. The amino acid sequences of α₂-antiplasmin, fibronectin, beta-casein, fibrinogen and thrombospondin can be found in the following references: α₂-antiplasmin precursor [M. Tone et al., J. Biochem, 102, 1033, (1987)]; beta-casein [L. Hansson et al, Gene, 139, 193, (1994)]; fibronectin [A. Gutman et al, FEBS Lett., 207, 145, (1996)]; thrombospondin-1 precursor [V. Dixit et al, Proc. Natl. Acad. Sci., USA, 83, 5449, (1986)]; R. F.Doolittle, Ann. Rev. Biochem., 53, 195, (1984);
peptides which are substrates or inhibitors of angiotensin, such as: angiotensin II Asp-Arg-Val-Tyr-Ile-His-Pro-Phe (E. C. Jorgensen et al, J. Med. Chem., 1979, Vol 22, 9, 1038-1044)
   [Sar, Ile] Angiotensin II: Sar-Arg-Val-Tyr-Ile-His-Pro-Ile (R. K. Turker et al., Science, 1972, 177, 1203).
Angiotensin I: Asp-Arg-Val-Tyr-Ile-His-Pro-Phe-His-Leu.

When the BTM is a peptide, one or both termini of the peptide, preferably both, have conjugated thereto a metabolism inhibiting group (M^{IG}). Having both peptide termini protected in this way is important for in vivo imaging applications, since otherwise rapid metabolism would be expected with consequent loss of selective binding affinity for the BTM peptide. By the term “metabolism inhibiting group” (M^{IG}) is meant a biocompatible group which inhibits or suppresses enzyme, especially peptidase such as carboxypeptidase, metabolism of the BTM peptide at either the amino terminus or carboxy terminus. Such groups are particularly important for in vivo applications, and are well known to those skilled in the art and are suitably chosen from, for the peptide amine terminus:

N-acylated groups —NH(C═O)R^{G} where the acyl group —(C═O)R^{G} has R^{G} chosen from: C₁₋₆ alkyl, C₃-₁₀ aryl groups or comprises a polyethyleneglycol (PEG) building block. Preferred such amino terminus M^{IG} groups are acetyl, benzyloxycarbonyl or trifluoroacetyl, most preferably acetyl.

Suitable metabolism inhibiting groups for the peptide carboxyl terminus include: carboxamide, tent-butyl ester, benzyl ester, cyclohexyl ester, amino alcohol or a polyethyleneglycol (PEG) building block. A suitable M^{IG} group for the carboxy terminal amino acid residue of the BTM peptide is where the terminal amine of the amino acid residue is N-alkylated with a C₁₋₄ alkyl group, preferably a methyl group. Preferred such M^{IG} groups are carboxamide or PEG, most preferred such groups are carboxamide.

In the further aspect, the dye of Formula IV preferably comprises at least one, more preferably one carboxyalkyl substituent chosen from the R¹ and R groups. That makes the dye bifunctional, by providing a functional group (carboxyl) through which the dye can be attached to the BTM.

General methods for conjugation of cyanine dyes to biological molecules are described by Licha et al [Topics Curr.Chem., 222, 1-29 (2002); Adv. Drug Deliv. Rev., 57, 1087-1108 (2005)]. Peptide, protein and oligonucleotide substrates for use in the invention may be labelled at a terminal position, or alternatively at one or more internal positions. For reviews and examples of protein labelling using fluorescent dye labelling reagents, see “Non-Radioactive Labelling, a Practical Introduction”, Garman, A. J. Academic Press,1997; “Bioconjugation—Protein Coupling Techniques for the Biomedical Sciences”, Aslam, M. and Dent, A., Macmillan Reference Ltd, (1998). Protocols are available to obtain site specific labelling in a synthesised peptide, for example, see Hermanson, G. T., “Bioconjugate Techniques”, Academic Press (1996).

The invention is illustrated by the following, non-limiting Examples. Example 1 provides the preparation of a precursor composition of the invention, based on Compound 3. Example 2 provides the preparation of a precursor composition of the invention, based on Compound 2. Example 3 provides the preparation of an intermediate composition of the invention, based on Compound 7. Example 4 provides the preparation of a dye composition of the invention, based on Compound 4 (Cy7). Example 5 provides HPLC conditions to analyse and purify the dye compositions of the second aspect.

### Abbreviations

ACN or MeCN: acetonitrile;

AcOH: acetic acid;

Ac₂O: acetic anhydride;

DIPEA: N,N-diisopropylethylamine;

DMF: N,N′-Dimethylformamide;

HPLC: high performance liquid chromatography;

LC-MS: Liquid chromatography mass spectroscopy;

TLC: Thin Layer Chromatography.

FIG. 1: Specific Compounds of the Invention.
(A)

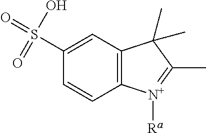

(B)

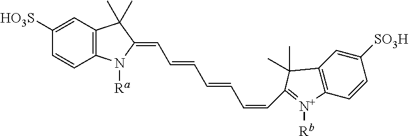

(C)

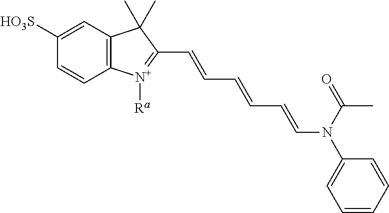

| Compound | Formula | R^{a} | R^{b} |
|---|---|---|---|
| 1 | A | —H | — |
| 2 | A | —CH₂CH₃ | — |
| 3 | A | —(CH₂)₅CO₂H | — |
| 4 | B | —(CH₂)₅CO₂H | —CH₂CH₃ |
| (Cy7) | | | |
| 5 | B | —(CH₂)₅CO₂H | —(CH₂)₅CO₂H |
| 6 | B | —CH₂CH₃ | —CH₂CH₃ |
| 7 | C | —(CH₂)₅CO₂H | — |

### Experimental

### EXAMPLE 1

### Preparation of 1-(ε-Carboxypentyl)-2,3,3-trimethyl indolenium-5-sulfonate (Compound 3).

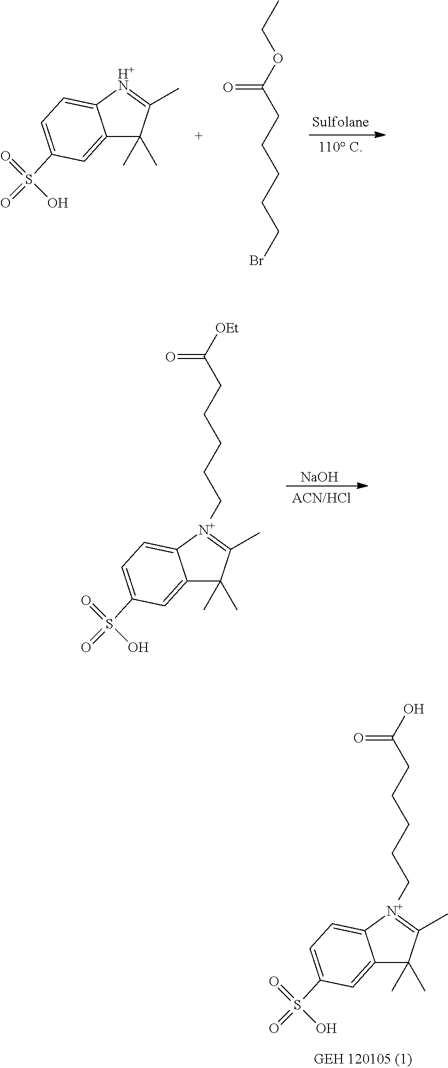

5-Sulfo-2,3,3-trimethyl indolenine sodium salt (purchased from Inta.Trade; Compound 1; 100 g, 0.381 mol) was charged into a reaction vessel (3 L). Sulfolane (Sigma-Aldrich; 400 ml) was added to it. Ethyl-6-bromo hexonate (Sigma-Aldrich; 140 ml, 0.760 mol) was then added to the mixture. The contents were heated to 110° C. with stirring and the reaction mixture was maintained at this temperature for 16 hrs. The reaction mixture was then cooled to ˜25° C. Ethyl acetate (1 L) was added. The mixture was stirred for 15 min, and the ethyl acetate layer was decanted. The reddish brown residue in the flask was washed with ethyl acetate (300 ml ×2). Deionised water (1 L) was added and the mixture was stirred for 15 min to obtain a clear solution. The solution was washed again using fresh ethyl acetate (500 ml×2). Traces of ethyl acetate were removed from the resulting solution on the rotary evaporator.

Sodium hydroxide (36 g, 0.90 mol) was added to the above solution and pH maintained between 10-12 (Note: pH>10 is critical for the completion of reaction). The reaction mixture was heated to 70° C. for 1 hr. The reaction mixture was neutralized using HCl (60 ml) and evaporated water to dryness on the rotary evaporator. The material was dried in vacuo at 30° C. for 16 hr. Acetonitrile (900 ml) was added to the above dried material. Concentrated hydrochloric acid (126 ml) was added slowly with stirring. The mixture was stirred at ˜25° C. for 15 min. The suspension was filtered, washed with 9:1 acetonitrile/conc. HCl (100 ml ×2) and dried.

The filtrate was concentrated to a viscous mass (Note: completely dried material takes longer time to crystallize and risks formation of the isopropyl carboxylate ester of Compound 3). The residue obtained was triturated with a mixture of isopropyl alcohol/acetone (150 ml/350 ml) for 15 min (The mixture is to be filtered immediately, to avoid the formation of the isopropyl ester). The suspension was filtered, washed with a mixture of isopropyl alcohol/acetone mixture (30/70 ml) and dried under vacuum at 50° C. for 8 hrs. Yield: 90 g (66%). HPLC Purity: 95% (at 270 nm).

### EXAMPLE 2

### Synthesis of 1-Ethyl-2,3,3-trimethyl-3H-indolium-5-sulfonate (Compound 2)

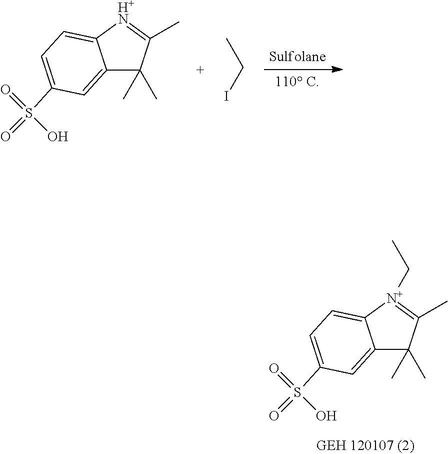

Compound 1 (Inta.Trade; 50 g, 0.19 mol) was suspended in sulfolane (350 ml) and heated at 90-100° C. for 30 min to obtain a clear solution. Ethyl iodide (34 ml, 2.2mol) was added to the above clear solution. The temperature of the reaction mass was maintained at 90-100° C. for 5-6 hrs. The reaction mass was cooled to ˜25° C. and then poured into ethyl acetate (1 L), with stirring. The precipitated solid was filtered and washed with ethyl acetate (400 ml). The solid obtained was triturated with 250 ml of acetonitrile for 16 hrs, filtered and washed with acetonitrile. Fresh acetonitrile (300 ml) was added to the solid and the mixture was refluxed for 1 hr. The suspension was filtered, washed with acetonitrile (50 ml) and dried under vacuum to obtain crude product. Yield: 40 g (78%). HPLC Purity: 90-93% (at 270 nm).

The crude solid 40 g, was dissolved in methanol (120 ml) at reflux temperature. The mixture was then cooled to room temperature (25° C.) and stirred overnight (16 hrs). The mixture was cooled to 5° C. and stirred for 30 min. The solid obtained was filtered, washed with cold methanol (40 ml) and dried in vacuo at 45° C. for 8 hrs. Yield: 25 g (62%). HPLC Purity: 98.7% (at 270 nm).

### EXAMPLE 3

### Synthesis of 1-(5-Carboxypentyl)-3,3-dimethyl-2-((1E,3E,5E)-6-(N-phenylacetamido)hexa-1,3,5-trienyl)-5-sulfo-3H-indolium (Compound 7)

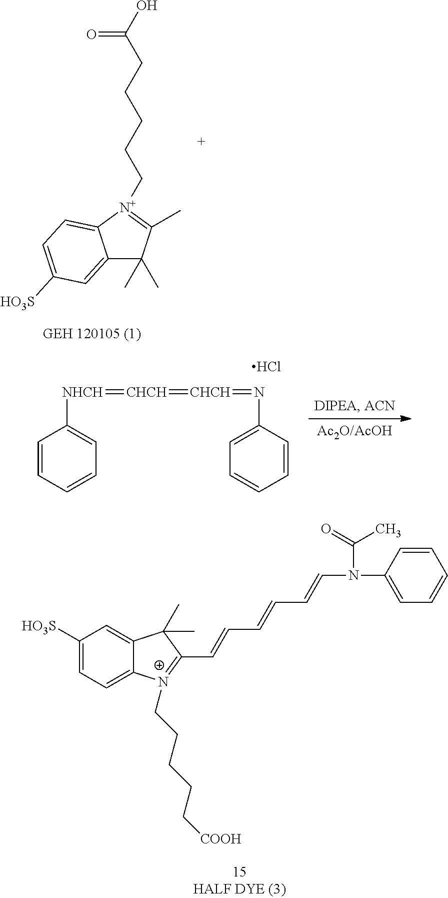

N-[5-(Phenylamino)-2,4-penta-dienylidene)aniline monohydrochloride (Compound X; Sigma-Aldrich; 8 g, 28.09 mmol) was suspended in acetonitrile (150 ml). Acetic anhydride (10.5 ml) was added followed by N,N-Diisopropylethylamine (4.8 ml, 29.39 mmol) and stirred at 25° C. for 1 hr to obtain a clear solution. The reaction mixture was then cooled to 15° C. A solution of Compound 3 (Example 1; 5 g, 1.12 mmol) in acetonitrile/acetic acid mixture (10 ml/20 ml) was added dropwise over a period of 15 minutes to the above cold solution. After completion of the addition, the cold bath was removed and the mixture stirred at 25° C. for 1 hr. The acetonitrile was then removed on a rotary evaporator. The residue was diluted with ethyl acetate (10 ml) and the resulting mixture poured slowly into a flask containing excess ethyl acetate (450 ml). The mixture was then stirred for 30min. The red suspension was filtered and washed with ethyl acetate and dried in vacuo for 2 hrs. Yield: 7 g (90%). HPLC purity: 93% (550 nm) and 80% (273 nm).

### EXAMPLE 4

### Synthesis of 2-((1E, 3E, 5E, 7E)-7-(1-(5-carboxypentyl)-3,3-dimethyl-5-sulphoindolin-2-ylidene) hepta-1,3,5-trienyl)-1-ethyl-3,3-dimethyl-5-sulfo-3H-indolium (Compound 4; Cy7)

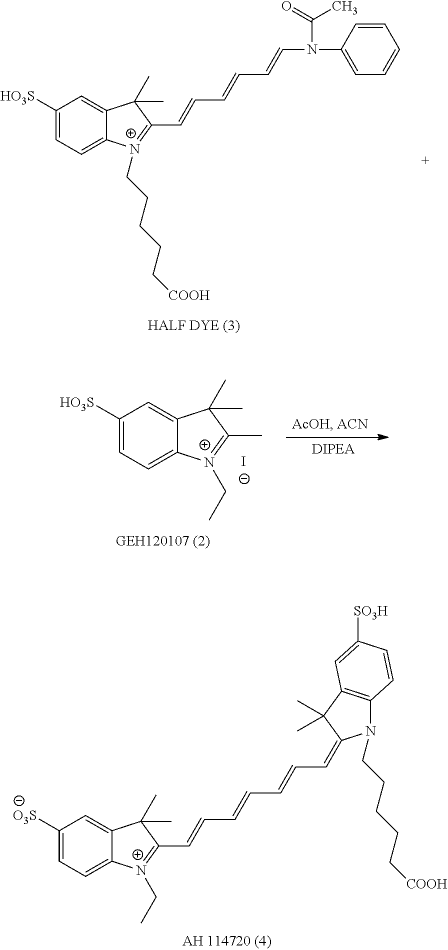

Compound 7 (Example 3; 6 g, 10.88 mmol) was dissolved in acetonitrile (150 ml). A solution of Compound 2 (Example 2; 3 g, 0.112 mmol) in acetic acid/acetonitrile (20/10 ml) was added. The reaction mixture was cooled to 15° C. N,N-Diisopropylethylamine (12 ml) was added dropwise over a period of 15 min. After completion of the addition, the cold bath was removed and the mixture stirred at 25° C. for 1 hr. The reaction mass was then poured into a flask containing excess ethyl acetate (600 ml). The mixture was stirred for 1 hour and the green product obtained was filtered and washed with ethyl acetate (100 ml) and dried in vacuo. The dried material was suspended in acetone (90 ml) and stirred overnight at room temperature. The suspension was then filtered, washed with acetone (50 ml) followed by ethyl acetate (50 ml) and dried in vacuo to yield the product as a green colored solid. Yield: 8 g (90%). HPLC purity: 90.9% (750 nm), 90.3% (550 nm) and 90% (273 nm).

### EXAMPLE 5

### LC-MS Purification And Analysis Methods

Each sample was prepared by dissolving 2-3 mg of the sample in water (1 ml) and filtering the solution through a 0.22-micron nylon filter. The chromatographic column used was Column-Agilent, Zorbax, C18, 5μ (4.6 mm×150 mm). Detection was via a photo diode array detector.

### (A). Precursor Compositions

| Chromatographic | Mobile phase: | | |
|---|---|---|---|
| conditions | Reservoir A: 0.1% TFA in water, | | |
| | Reservoir C: Acetonitrile. | | |
| | Flow rate: 0.3 ml/min. | | |
| | Detector wavelength: 254 nm. | | |
| | Injection volume: 3 μl | | |
| | Column temp: 30° C. | | |
| Gradient | Time in Min | % A | % C |
| | 0 | 99 | 1 |
| | 3.0 | 99 | 1 |
| | 15.0 | 1 | 99 |
| | 19.0 | 1 | 99 |
| | 20.0 | 99 | 1 |
| | 30.0 | 99 | 1 |

| | |
|---|---|
| Mass parameters | Ion source: MM ESI + APCI + ve mode |
| | Vaporizer temp: 200° C. |
| | Nebulizer pressure 60 |
| | Drying gas temp 350° C. |
| | Corona current 1 μA |

The retention times of Compound 2 and Compound 3 were 13.4 and 14.4 minutes respectively.

### (B) Intermediate And Dye Compositions

| Chromatographic | Mobile phase; | | |
|---|---|---|---|
| conditions | Reservoir A: 10 mM ammonium acetate | | |
| | (pH 6.5) buffer in water | | |
| | Reservoir C: Buffer/Acetonitrile: 10/90 | | |
| | Flow rate: 0.3 ml/min | | |
| | Detector wavelength: 214, 254 nm, 273 nm, | | |
| | 380 nm, 450 nm, 550 nm, and 750 nm. | | |
| | Injection volume: 5 μl | | |
| | Column temp: 30° C. | | |
| | Data acquisition: 11 min | | |
| Gradient | Time in Min | % A | % C |
| | 0 | 85 | 5 |
| | 2.0 | 85 | 5 |
| | 7.0 | 0 | 100 |
| | 10.0 | 0 | 100 |
| | 11.0 | 85 | 5 |
| | 15.0 | 85 | 5 |

| | |
|---|---|
| Mass parameters | Ion source: MM ESI + APCI + ve mode |
| | Vaporizer temp: 200° C., |
| | Dry gas: 12 l/min |
| | Nebulizer pressure: 60, |
| | Drying gas temp: 325° C., |
| | Corona current: 2 μA. |

The retention times of Compound 4 and Compound 7 were 4.88 and 4.59 minutes respectively.

What is claimed is:

1.-16. (canceled)

17. A precursor composition which comprises a quaternary compound of Formula I and a sulfonate ester of Formula II: 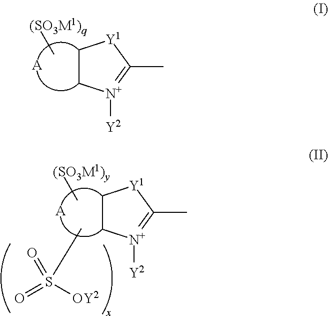
characterised in that the molar ratio of (I): II) is at least 30:1,
wherein:
A represents the atoms necessary to complete a phenyl or naphthyl ring;
Y¹ is —O—, —S—, —NR¹— or —CR²R³—;
Y² is an R group and is the same at all locations within Formula II;
each M¹ is independently H or B^{c}, where B^{c} is a biocompatible cation;
R¹ is an R group;
R² and R³ are independently C₁₋₃ alkyl or C₁₋₆ carboxyalkyl;
each R is independently C₁₋₅ alkyl or C₁₋₆ carboxyalkyl;
q is an integer of value 1 to 4;
x is an integer of value 1 to 4, y is an integer of value 0 to 3, wherein
x and y are chosen such that (x+y)=q.

18. The precursor composition of claim 17, where Y¹ is —CR²R³—.

19. The precursor composition of claim 17, where q is 1 or 2.

20. The precursor composition of claim 17, where the quaternary compound is of Formula IA and the sulfonate ester is of Formula IIA: 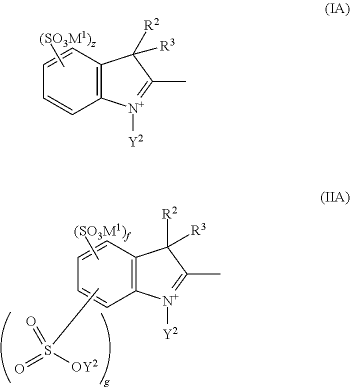
where:
z is 1 or 2;
f is 0 or 1, g is 1 or 2 and (f+g)=z.

21. The precursor composition of claim 20, where z is 1.

22. A dye composition which comprises a cyanine dye of Formula IV, and sulfonate ester of Formulae IVE: 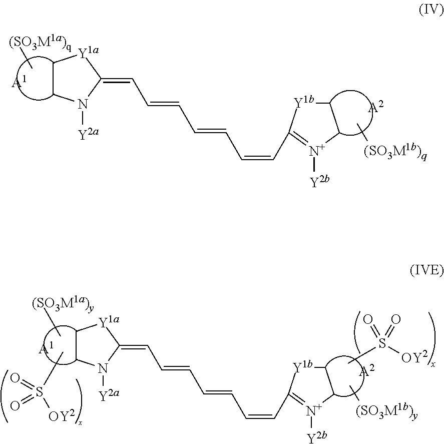
characterised in that the molar ratio of (IV): (IVE) is at least 30:1,
wherein:
A¹ and A² each independently represents the atoms necessary to complete a phenyl or naphthyl ring;
M^{1a} and M^{1b} are each independently H or B^{c}, where B^{c} is a biocompatible cation;
Y^{1a} and Y^{1b} are each independently —O—, —S—, —NR¹— or —CR²R³—;
Y^{2a} and Y^{2b} are each an R group and the same at all locations within Formula II;
R¹ is an R group;
R² and R³ are independently C₁₋₃ alkyl or C₁₋₆ carboxyalkyl;
each R is independently C₁₋₅ alkyl or C₁₋₆ carboxyalkyl;
each q is independently an integer of value 1 to 4;
x is an integer of value 1 to 4, y is an integer of value 0 to 3, wherein at each A^{l} or
A² ring location of Formula IVE, x and y are chosen such that (x+y)=q of Formula IV;
and wherein at least one of A¹, Y^{1a} and Y²a is different from A², Y^{1b} and Y^{2b} respectively.

23. An intermediate composition which comprises an amide of Formula V and a polyene salt of Formula X: 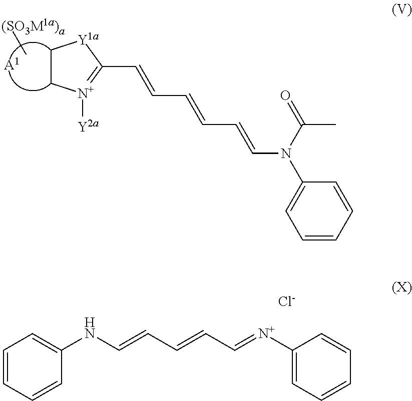
characterised in that the molar ratio of (V): (X) is at least 90:1,
wherein
A¹ represents the atoms necessary to complete a phenyl or naphthyl ring;
M^{1a} is H or B^{c}, where B^{c} is a biocompatible cation;
Y^{1a} is —O—, —S—, —NR¹— _{or —CR}²_{R}³—;
Y^{2a} a is an R group;
R¹ is an R group;
R² and R³ are independently C₁₋₃ alkyl or C₁₋₆ carboxyalkyl;
each R is independently C₁₋₅ alkyl or C₁₋₆ carboxyalkyl;
a is an integer of value 1 to 4.

24. A process for the preparation of a dye composition which comprises a cyanine dye of Formula IV, and sulfonate ester of Formulae IVE: 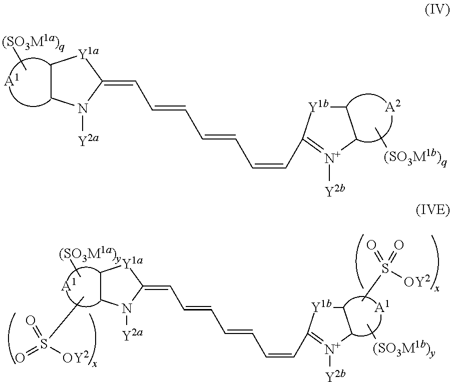
characterised in that the molar ratio of (IV): (IVE) is at least 30:1,
which process comprises reaction of an intermediate composition which comprises an amide of Formula V and a polyene salt of Formula X: 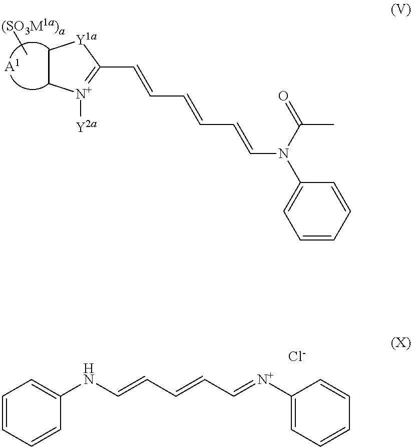
characterised in that the molar ratio of (V): (X) is at least 90:1,
with one molar equivalent of the precursor composition of claim 17 in a suitable solvent, wherein for said precursor composition the quaternary compound is of Formula IB and the sulfonate ester is of Formula IIB: 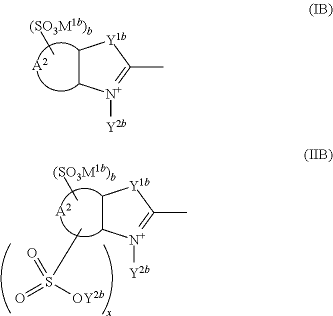
wherein:
A, A¹ and A² each independently represents the atoms necessary to complete a phenyl or naphthyl ring;
M¹, M^{1a} and M^{1b} are each independently H or B^{c}, where B^{c} is a biocompatible cation;
Y¹, Y^{1a} and Y^{1b} are each independently —O—, —S—, —NR¹— or —CR²R³—;
Y², Y^{2a} and Y^{2b} are each an R group and the same at all locations within Formula II;
R¹ is an R group;
R² and R³ are independently C₁₋₃ alkyl or C₁₋₆ carboxyalkyl;
each R is independently C₁₋₅ alkyl or C₁₋₆ carboxyalkyl;
each q is independently an integer of value 1 to 4;
x is an integer of value 1 to 4, y is an integer of value 0 to 3, wherein at each A¹ or A² ring location of Formula IVE, x and y are chosen such that (x+y)=q of Formula IV;
a and b is each an integer of value 1 to 4;
and wherein at least one of A¹, Y^{1a} and Y²a is different from A², Y^{1b} and Y^{2b} respectively.

25. Use of the precursor composition of claim 17 in the synthesis of a sulfonated dye, or in the synthesis of the dye intermediate composition which comprises an amide of Formula V and a polyene salt of Formula X: 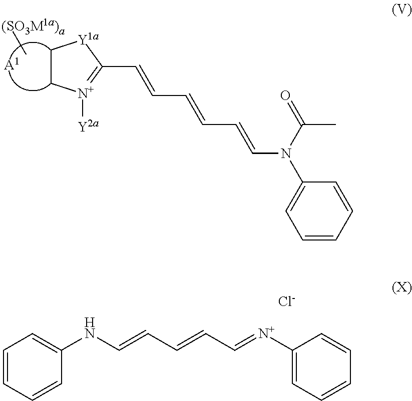
characterised in that the molar ratio of (V): (X) is at least 90:1,
wherein
A¹ represents the atoms necessary to complete a phenyl or naphthyl ring;
M^{1a} is H or B^{c}, where B^{c} is a biocompatible cation;
Y^{1a} is —O—, —S—, —NR¹— or —CR²R³—;
Y^{2a} is an R group;
R¹ is an R group;
R² and R³ are independently C₁₋₃ alkyl or C₁₋₆ carboxyalkyl;
each R is independently C₁₋₅ alkyl or C₁₋₆ carboxyalkyl;
a is an integer of value 1 to 4.

26. Use of the intermediate composition of claim 23 in the synthesis of a sulfonated dye.

27. A pharmaceutical composition which comprises the dye composition of claim 22, in a biocompatible carrier medium, in sterile form suitable for mammalian administration.

28. Use of the dye composition of claim 22 or a pharmaceutical composition which comprises the dye composition of claim 22, in a biocompatible carrier medium, in sterile form suitable for mammalian administration, in the preparation of a conjugate of the unsymmetrical dye of Formula IV with a biological targeting moiety or a synthetic macromolecule.

29. The use of claim 28, where the biological targeting moiety is chosen from:
(i) a 3-100 mer peptide;
(ii) an enzyme substrate, enzyme antagonist or enzyme inhibitor;
(iii) a receptor-binding compound;
(iv) an oligonucleotide;
(v) an oligo-DNA or oligo-RNA fragment.


SEQUENCE LISTING (9 sequences)

SEQ ID NO: 1 - protein, 5 aa, Artificial
  synthetic peptide
YIGSR

SEQ ID NO: 2 - protein, 5 aa, Artificial
  synthetic peptide
PDSGR

SEQ ID NO: 3 - protein, 5 aa, Artificial
  synthetic peptide
IKVAV

SEQ ID NO: 4 - protein, 3 aa, Artificial
  synthetic peptide
LRE

SEQ ID NO: 5 - protein, 15 aa, Artificial
  synthetic peptide
KCQAGTFALRGDPQG

SEQ ID NO: 6 - protein, 3 aa, Artificial
  synthetic peptide
RGD

SEQ ID NO: 7 - protein, 8 aa, Artificial
  synthetic peptide
DRVYIHPF

SEQ ID NO: 8 - protein, 8 aa, Artificial
  synthetic peptide
XRVYIHPI

SEQ ID NO: 9 - protein, 10 aa, Artificial
  synthetic peptide
DRVYIHPFHL